(19) United States
(12) Patent Application Publication
(10) Pub. No.: US 2025/0173922 A1
(43) Pub. Date: May 29, 2025

(54) METHOD AND SYSTEM FOR COMPRESSING DATA REPRENTATIVE OF A MAPPING FOR USE IN IMAGE PROCESSING

(71) Applicant: Arm Limited, Cambridge (GB)

(72) Inventors: David Hanwell, Sale (GB); Yushu Liu, Hsinchu (TW); Alexis Leonardo Lluis Gomez, Chelford (GB)

(73) Assignee: Arm Limited, Cambridge (GB)

(21) Appl. No.: 18/963,621

(22) Filed: Nov. 28, 2024

(30) Foreign Application Priority Data
Nov. 28, 2023 (GB) 2318152.2

(51) Int. Cl. G06T 11/00

(52) U.S. Cl. CPC G06T 11/001

(57) ABSTRACT

A method for compressing data representative of a mapping for use in image processing. The method comprises determining, based on a plurality of mappings representing a look-up table, parameters of a function for transforming a given set of input pixel attribute values into a set of estimated output pixel attribute values. The method comprises, for a plurality of the sets of input pixel attribute values, determining, based on the function and the set of input pixel attribute values, a set of approximate values of the associated set of output pixel attribute values, and determining, based on the associated set of output pixel attribute values and the set of approximate values, a set of residual output pixel attribute values. The method comprises storing data representative of the parameters of the function and data representative of the sets of residual output pixel attribute values.

### CROSS-REFERENCE TO RELATED APPLICATION

This application claims the benefit under 35 U.S.C. § 119(a) and 37 CFR § 1.55 to UK patent application no. 2318152.2, filed on Nov. 28, 2023, the entire content of which is incorporated herein by reference.

### TECHNICAL FIELD

The present invention relates to image processing and in particular, compressing data representative of a mapping for use in image processing.

### BACKGROUND

Mappings from input pixel attribute values to output pixel attribute values are used in a variety of contexts in image processing. For example, colour mapping involves mapping red, green and blue (RGB) pixel intensity values received from an image sensor, to output red, green and blue pixel intensity values. Colour mapping may be used to calibrate image sensors with different sensitivities to different colours of light, and to enhance colour contrast in certain colour ranges, such as colour ranges that represent skin tones. As another example, tonemapping is used to transform pixel intensity values representing a high dynamic range scene that is to be displayed using a display apparatus with a low dynamic range.

A look-up table can be used to store a precise and finely tuned mapping. The look-up table includes, for example, entries that represent predetermined input RGB values and their associated output RGB values. However, the look-up table may include many hundreds or thousands of entries, and as a result may occupy an undesirably large amount of memory space. It is desirable to reduce the memory occupied by data representing a mapping for use in image processing.

### SUMMARY

According to a first aspect of the present invention, there is provided a method for compressing data representative of a mapping for use in image processing, the data comprising a plurality of mappings representing a look-up table, said mappings being from a respective set of one or more input pixel attribute values representing respectively one or more input data channels, to an associated set of one or more output pixel attribute values representing respectively one or more output data channels, the method comprising: determining, based on the plurality of mappings, one or more parameters of a function for transforming a given set of one or more input pixel attribute values representing respectively the input data channels, into a set of one or more estimated output pixel attribute values representing respectively the output data channels; for a plurality of the sets of input pixel attribute values: determining, based on the function and the set of input pixel attribute values, a set of approximate values of one or more of the associated set of output pixel attribute values; and determining, based on the associated set of output pixel attribute values and the set of approximate values, a set of one or more residual output pixel attribute values; and storing data representative of the parameters of the function and data representative of the sets of residual output pixel attribute values.

Optionally, the method comprises compressing said residual output pixel attribute values to obtain compressed residual output pixel attribute values, and the data representative of the sets of residual output pixel attribute values is data representative of the compressed residual output pixel attribute values.

Optionally, determining the set of residual output pixel attribute values comprises performing a difference operation with the associated set of predetermined output pixel attribute values and the set of approximate values.

Optionally, determining the parameters of the function comprises estimating the function from the plurality of mappings using random sample consensus.

Optionally, a total number of the sets of residual output pixel attribute values is fewer than a total number of the mappings in the plurality of mappings.

According to a second aspect of the present invention, there is provided a method for determining a mapping from a set of one or more input pixel attribute values representing respectively one or more input data channels, to a set of one or more output pixel attribute values representing respectively one or more output data channels, the method comprising: obtaining one or more parameters of a function for transforming a given set of one or more input pixel attribute values representing respectively the input data channels, into a set of one or more output pixel attribute values representing respectively the output data channels; obtaining a set of one or more residual output pixel attribute values representing respectively the output data channels; determining, based on the function and the set of input pixel attribute values, a set of one or more approximate output pixel attribute values representing respectively the output data channels; and determining, based on the set of approximate values and the set of residual output pixel attribute values, the set of output pixel attribute values representing respectively the output data channels.

Optionally, determining the set of output pixel attribute values comprises performing an addition operation with the set of approximate output pixel attribute values and the set of residual output pixel attribute values.

Optionally, the set of input pixel attribute values is a target set of input pixel attribute values, and obtaining the set of residual output pixel attribute values comprises: obtaining a plurality of sets of one or more residual output pixel attribute values representing respectively the output data channels, the plurality of sets of residual output pixel attribute values being associated with a respective plurality of sets of one or more input pixel attribute values representing respectively the input data channels; and based on the target set of input pixel attribute values, interpolating from the plurality of sets of one or more residual output pixel attribute values to obtain the set of residual output pixel attribute values.

Optionally, the input data channels comprise three data channels, the plurality of sets of residual output pixel attribute values comprises eight said sets of residual output pixel attribute values, and the interpolating comprises trilinear interpolation from the eight sets of residual output pixel attribute values.

Optionally, the method comprises: obtaining a further set of one or more residual output pixel attribute values representing respectively the output data channels; determining, based on the function and a further set of one or more input pixel attribute values representing respectively the input data channels, a further set of one or more approximate output pixel attribute values representing respectively the output data channels; determining, based on the further set of approximate output pixel attribute values and the further set of residual output pixel attribute values, a further set of one or more output pixel attribute values representing respectively the output data channels; and based on a target set of one or more input pixel attribute values representing respectively the input data channels, interpolating from the set of output pixel attribute values and the further set of output pixel attribute values to obtain a target set of one or more output pixel attribute values representing respectively the output data channels.

Optionally, the function comprises an affine transformation.

Optionally, the input data channels comprise three colour channels, and the output data channels comprise the three colour channels.

Optionally, the one or more input data channels comprises an input pixel intensity value channel, and the one or more output data channels comprises a tonemapped pixel intensity value channel.

Optionally, the input data channels comprise a channel for a first pixel characteristic and a channel for a second pixel characteristic, wherein the second pixel characteristic is different from the first pixel characteristic.

Optionally, the channel for the first pixel characteristic is the input pixel intensity value channel, and the channel for the second pixel characteristic is a pixel location channel.

According to a third aspect of the present invention, there is provided a system comprising a processor and a memory, the system being configured to perform the method of the first aspect and/or the second aspect.

According to a fourth aspect of the present invention, there is provided a non-transitory computer readable medium comprising instructions which, when executed by a processor, cause the processor to perform the method of the first aspect and/or the second aspect.

### BRIEF DESCRIPTION OF THE DRAWINGS

FIG. 1 is a schematic diagram showing a method of compressing data representative of a mapping for use in image processing according to examples;

FIG. 2 shows an illustration of a Bayer filter according to examples;

FIG. 3a shows a colour mapping between input red and blue pixel intensity values and output red and blue pixel intensity values, according to examples;

FIG. 3b shows a residual colour mapping between input red and blue pixel intensity values and residual output red and blue pixel intensity values, according to examples;

FIG. 4 shows a tonemapping method, according to examples;

FIG. 5 is a schematic diagram showing a method for determining a mapping from a set of input pixel attribute values to a set of output pixel attribute values, according to examples; and

FIG. 6 shows a schematic diagram showing a computing system according to examples.

### DETAILED DESCRIPTION

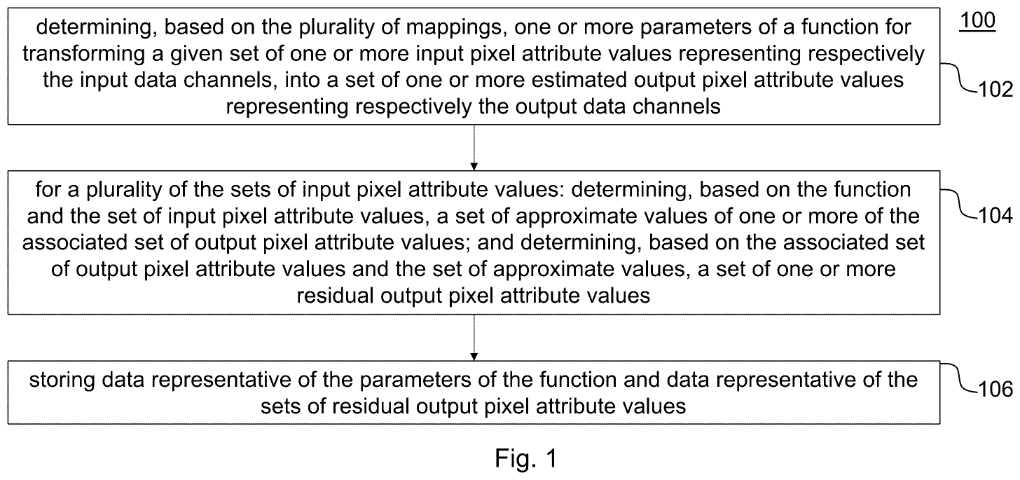

Referring to FIG. 1, there is illustrated a method 100 for compressing data representative of a mapping for use in image processing. The data comprises a plurality of mappings representing a look-up table 30. The mappings are from a respective set of one or more input pixel attribute values 31 representing respectively one or more input data channels, to an associated set of one or more output pixel attribute values 32 representing respectively one or more output data channels.

In broad overview, the method comprises:
in step 102, determining, based on the plurality of mappings, one or more parameters of a function for transforming a given set of one or more input pixel attribute values 31 representing respectively the input data channels, into a set of one or more estimated output pixel attribute values representing respectively the output data channels;
in step 104, for a plurality of the sets of input pixel attribute values 31: determining, based on the function and the set of input pixel attribute values 31, a set of approximate values of one or more of the associated set of output pixel attribute values 32; and determining, based on the associated set of output pixel attribute values 32 and the set of approximate values, a set of one or more residual output pixel attribute values 34; and
in step 106, storing data representative of the parameters of the function and data representative of the sets of residual output pixel attribute values 34.

Accordingly, data representative of a mapping for use in image processing may be compressed.

In a first example method 100a, which includes the steps of method 100, the input data channels comprise three colour channels, and the output data channels comprise the three colour channels. In method 100a, the three colour channels are red, green and blue colour channels.

We now describe generally how an image sensor may be used to obtain pixel intensity values for the red, green and blue colour channels.

Image sensors may comprise an array of sensor elements, also referred to as sensor pixels. The sensor elements may each comprise a photosensitive element, also called a photosensor, for example a photodiode that can convert incident light into electronic signals or data. The sensor elements may comprise any photosensor suitable for capturing images. Further examples of sensor element photosensitive elements may include charge-coupled devices (CCDs) or complementary metal-oxide semiconductors (CMOSs). When capturing frames of image data, the image sensor may be exposed to incident light for a predetermined period of time, called an exposure interval. Alternatively, the image sensor may be continually exposed to incident light and signals from the sensor may be read over a given period of time which may also be referred to as an exposure interval. During this exposure, incident photons are converted into electrons by the photosensor and the charge may be stored by a capacitor. Each sensor element may further comprise circuitry configured to measure the charge stored by their respective capacitor and to convert the amount of charge stored to a digital value. The pixel intensity values may comprise these digital values. The pixel intensity values may represent at least one characteristic of the light captured by an image sensor. The pixel intensity values may be representative of an amount of light energy incident on each sensor element during the exposure interval, and the amount of light energy may be proportional to the number of photons captured by that sensor element. An image sensor may, for a variety of reasons, fail to detect a photon incident on the sensor element. The image sensor may have a greater failure rate for photons of some wavelengths (colours) than others. The dependence of the failure rate on the wavelength is a property of an image sensor which can vary among image sensors. The pixel intensity values may represent a luminance of captured light, which is for example a measure of the energy per unit area rather than absolute energy. In other examples, the image data may be representative of a brightness of captured light, which may be considered to correspond to a perception of luminance, which may or may not be proportional to luminance. The image data may be representative of any photometric quantity or characteristic that may be used to represent the visual appearance of the images represented by the image data. The image data may be generated and/or stored in any suitable format, for example raw image format.

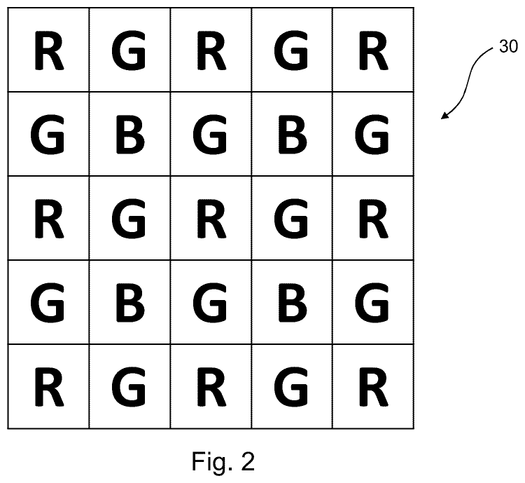

In method 100a, the image sensor includes a colour filter array that includes a pattern of colour filter elements. Colour filter elements correspond to respective sensor pixels of an array of sensor pixels of the image sensor 100. For example, the colour filter array may form a mosaic or repeating pattern, such as the Bayer filter 30 illustrated in FIG. 2, which illustrates an array of red (R), green (G) and blue (B) filters. A colour filter element generally allows light of a particular colour to pass through to the corresponding sensor pixel. In this way, the colour filter array allows different sensor pixels of the array of sensor pixels to receive different colours of incident light, allowing a full-colour image to be captured. As typical photosensors are not sensitive to the wavelength of incoming light, typical sensor pixels would be unable to provide colour information from the detected light without a colour filter array. However, by separating incoming light into different wavelength ranges, corresponding to different colours, using the colour filter array, the intensity of light in these different wavelength ranges can be ascertained, allowing this colour information to be determined.

It is to be appreciated that a colour may refer to any range of wavelengths of light. For example, a clear, transparent or white colour filter element may nevertheless be considered to be a colour filter element in the sense that the colour filter element allows these particular wavelengths (such as all or substantially all) wavelengths in the visible spectrum to be transmitted to the underlying sensor pixel. In other examples, some or all of the colour filter elements may be non-white colour filter elements.

As mentioned, method 100 is a method for compressing data representative of a mapping for use in image processing. The data comprises a plurality of mappings representing a look-up table 30. The mappings are from a respective set of one or more input pixel attribute values 31 representing respectively one or more input data channels, to an associated set of one or more output pixel attribute values 32 representing respectively one or more output data channels. In some examples, the input pixel attribute values 31 are input pixel intensity values, and the output pixel attribute values 32 are output pixel intensity values.

In method 100a, the data representative of the mapping is data representative of a colour mapping, and the plurality of mappings are each from a respective set of predetermined input pixel intensity values 31 representing respectively the red, green and blue colour channels, to an associated set of predetermined output pixel intensity values 32 representing respectively the red, green and blue colour channels.

A colour mapping takes a set of input red, green and blue pixel intensity values and returns a set of output red, green and blue pixel intensity values. Colour mappings have a variety of uses. Firstly, as discussed above, different image sensors may have different sensitivities to light of different wavelengths, and hence one image sensor taking an image of an object may generate input pixel intensity values that represent an image that is, for example, bluer (i.e. the blue pixel intensity values are greater) than an image taken by another image sensor of the same object, even under the same illumination. Respective colour mappings for different sensors can calibrate the output pixel intensity values, so that the output pixel intensity values represent the same hue (which can be defined as, for example, the ratio of the output red pixel intensity value to the output blue pixel intensity value) regardless of the image sensor that is used to capture an image of the object.

Colour mappings have other uses. For example, it may be desirable to provide greater contrast in hue between some colours than what is represented by the input pixel intensity values. For example, it may be desirable to enhance the contrast between different skin tones. To this end, for two sets of input pixel intensity values representing respectively two input hues, a colour mapping can be used to produce two respective sets of output pixel intensity values representing respectively two output hues, where the difference between the output hues is greater than the difference between the input hues.

It will be appreciated that in general, due to the complexity of the above-mentioned requirements, a desired colour mapping cannot be represented perfectly using a simple analytic function. Indeed, it is desirable to be able to tweak parameters of a colour mapping to change the set of output pixel intensity values produced for one set of input pixel intensity values, without changing the sets of output pixel intensity values produced for every, or even any, other set of input pixel intensity values. To this end, according to method 100a, the colour mapping is represented by a look-up table 30.

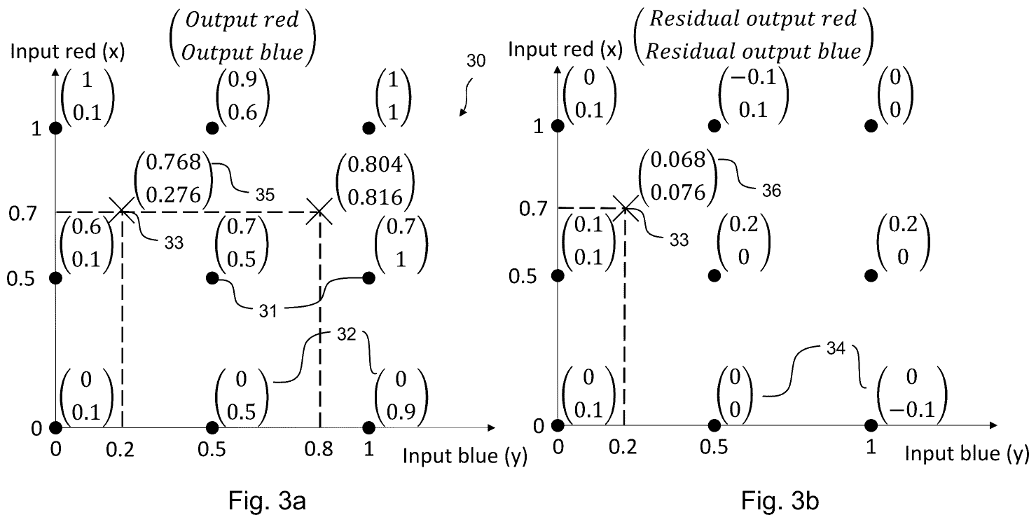

FIG. 3a illustrates an example look-up table 30. In FIG. 3a, the y-axis (shown as horizontal in the Figure) represents the input pixel intensity value representing the blue colour channel, and the x-axis (shown as vertical in the Figure) represents the input pixel intensity value representing the red colour channel. For each of the sets of predetermined input pixel intensity values 31 (0, 0), (0, 0.5), (0, 1), (0.5, 0), (0.5, 0.5), (0.5, 1), (1, 0), (1, 0.5), and (1, 1), a mapping to a set of predetermined output pixel intensity values 32 is provided. The predetermined output pixel intensity values 32 may be determined to achieve the colour calibration discussed above, and/or tuned to enhance the contrast between different skin tones. In this example, 0 is the minimum value that a pixel value of a particular colour channel can take, and 1 is the maximum value that it can take. As can be seen by inspecting the predetermined output pixel intensity values 32, the look-up table 30 cannot be represented as a matrix transformation, or even an affine transformation, from input red and blue pixel intensity values to output red and blue pixel intensity values. For this reason, a look-up table 30 is preferable to, for example, a matrix transformation alone, as a means of storing a precise colour mapping. For a set of input pixel intensity values that is not one of the sets of predetermined input pixel intensity values 31, an output set of pixel intensity values may be determined by linearly interpolating from the sets of predetermined output pixel intensity values 31. For the set of input pixel intensity values (0.7, 0.8), the sets of predetermined input pixel intensity values 31 (0.5, 0.5), (0.5, 1), (1, 0.5), and (1, 1) can be bilinearly interpolated to provide the output set of pixel intensity values (0.804, 0.816). Hence, the look-up table 30 can be used to determine a set of output pixel intensity values for any set of input pixel intensity values.

The green colour channel is omitted from FIG. 3a for simplicity of explanation. FIG. 3a represents a two-dimensional vector function of a two-dimensional vector input. In practice, a three-dimensional vector function of a three-dimensional vector input is used, with the three input dimensions (channels) representing the input red, green and blue colour channels respectively, and the three output dimensions (channels) representing the output red, green and blue colour channels respectively.

In practice, the colour mapping is in general much more precise than the mapping outlined in FIG. 3a. The colour mapping in FIG. 3a shows the predetermined output pixel intensity values 32 for nine sets of predetermined input pixel intensity values 31 arranged in the 3×3 square grid shown. In method 100a, there may be 729 sets of predetermined input pixel intensity values 31 arranged in a 9×9×9 cubic grid. In addition, in FIG. 3a, the predetermined output pixel intensity values 32 are stored to one significant figure. In method 100a, the predetermined output pixel intensity values 32 may be stored as 10-bit values, leading to a total storage requirement of 21,870 bits.

The present invention offers a method to reduce the memory that is used to store the colour mapping.

As mentioned, at step 102, the method comprises determining, based on the plurality of mappings, one or more parameters of a function. The function is a function for transforming a given set of one or more input pixel attribute values 31 representing respectively the input data channels, into a set of one or more estimated output pixel attribute values representing respectively the output data channels.

In method 100a, the function is a function for transforming an arbitrary set of input pixel intensity values representing the red, green and blue colour channels, into a set of estimated output pixel intensity values representing respectively the red, green and blue colour channels. The function is essentially an approximation of the original, precise, colour mapping. However, the function can evaluate the set of estimated output pixel intensity values without needing to interpolate from a look-up table. In general, the function is a continuous function. In some examples, the function comprises an analytic function.

Any suitable function may be used. In one example, the function comprises an affine transformation. For example, the function may comprise the following transformation.

$$[ \begin{matrix}{R}^{*} \\ {G}^{*} \\ {B}^{*} \\ K\end{matrix} ] = [ \begin{matrix}{H}_{11} & {H}_{12} & {H}_{13} & {H}_{14} \\ {H}_{21} & {H}_{22} & {H}_{23} & {H}_{24} \\ {H}_{31} & {H}_{32} & {H}_{33} & {H}_{34} \\ {H}_{41} & {H}_{42} & {H}_{43} & {H}_{44}\end{matrix} ] \times [ \begin{matrix}{R}_{i} \\ {G}_{i} \\ {B}_{i} \\ 1\end{matrix} ]$$

Here, Rᵢ, Gᵢ and Bᵢ are the input pixel intensity values representing the red, green and blue colour channels respectively, and R*, G* and B* are the output pixel intensity values representing the red, green and blue colour channels respectively. In this example, K is an output of the function which is not used. In this example, the parameters of the function comprise the coefficients of the 4×4 matrix shown above. Alternatively, the function may comprise using K as follows.

$$\{ \begin{matrix}{R}_{0} = \frac{{R}^{*}}{K} = \frac{{H}_{11} {R}_{i} + {H}_{12} {G}_{i} + {H}_{13} {B}_{i} + {H}_{14}}{K} \\ {G}_{0} = \frac{{G}^{*}}{K} = \frac{{H}_{21} {R}_{i} + {H}_{22} {G}_{i} + {H}_{23} {B}_{i} + {H}_{24}}{K} \\ {B}_{0} = \frac{{B}^{*}}{K} = \frac{{H}_{31} {R}_{i} + {H}_{32} {G}_{i} + {H}_{33} {B}_{i} + {H}_{34}}{K} \\ K = {H}_{41} {R}_{i} + {H}_{42} {G}_{i} + {H}_{43} {B}_{i} + {H}_{44}\end{matrix}$$

Here, R₀, G₀ and B₀ are the output pixel intensity values representing the red, green and blue colour channels respectively.

Alternatively, the function may comprise, for each output colour channel, a sum of a plurality of polynomials, each polynomial being a polynomial function of an input pixel intensity value representing a respective colour channel. The polynomials may be different for the different output colour channels. In this example, the parameters of the function comprise the coefficients of the polynomials.

In the example of FIG. 3a, the function may comprise the 2×2 identity matrix.

In any case, the number of parameters of the function is small in comparison with the number of exact output pixel intensity values stored in the look-up table 30. For example, the function may have fewer than 30 parameters, fewer than 20 parameters, fewer than 10 parameters, or fewer than 5 parameters.

In method 100a, determining the function comprises estimating the function from the plurality of mappings using random sample consensus. However, any suitable parameter fitting method may be used to determine the function, such as a least-squares method. In some examples, separate parameter fitting processes are performed for the different output colour channels.

As mentioned, the method comprises, in step 104, for a plurality of the sets of input pixel attribute values 31, determining, based on the function and the set of input pixel attribute values 31, a set of approximate values of one or more of the associated set of output pixel attribute values 32. Determining the set of approximate values may comprise applying the function to the set of input pixel attribute values 31. In some examples, the plurality of sets of input pixel attribute values 31 comprises several, or all, of the sets of input pixel attribute values 31 in the look-up table 30.

In method 100a, the set of approximate values is a set of values that approximates the set of predetermined output pixel intensity values 32. For this reason, hereinafter, the set of predetermined output pixel intensity values 32 may be referred to as a set of exact output pixel intensity values. The number of bits used to represent a given approximate value may be the same as the number of bits used to represent the corresponding exact output pixel intensity value.

As an illustrative example, the method may comprise multiplying the identity matrix (which was determined as the approximating function) by the set of input pixel intensity values (0.5, 0.5) to determine, for the predetermined set of input pixel intensity values (0.5, 0.5) in FIG. 3a, the set of approximate values (0.5, 0.5).

As mentioned, the method comprises, in step 104, for the plurality of sets of input pixel attribute values 31, determining, based on the associated set of output pixel attribute values 32 and the set of approximate values, a set of one or more residual output pixel attribute values 34. In some examples, determining the set of residual output pixel attribute values 34 comprises performing a difference operation with the associated set of predetermined output pixel attribute values 32 and the set of approximate values. For example, determining the set of residual output pixel attribute values 34 may comprise subtracting the approximate values from the respective predetermined output pixel attribute values 32.

In method 100a, the set of residual output pixel attribute values 34 is a set of residual output pixel intensity values 34 representing respectively the red, green and blue colour channels. FIG. 3b shows what the residual output pixel intensity values 34 would be for the predetermined output pixel intensity values 32 shown in FIG. 3a, where the approximating function is the identity matrix. As an illustrative example, the method may comprise, for the predetermined set of input pixel intensity values (0.5, 0.5), subtracting the set of approximate values (0.5, 0.5) from the predetermined set of output pixel intensity values (0.7, 0.5), to obtain the set of residual output pixel intensity values (0.2, 0).

As can be seen, the residual output pixel intensity values 34 are much smaller than the exact output pixel intensity values. They can therefore be represented using a smaller number of bits than the exact output intensity values. In general, the first few bits of a residual output pixel intensity value can be expected to be 0, because the residual output pixel intensity value is smaller than the exact output pixel intensity value. Therefore, method 100a comprises removing redundant bits from the residual output pixel intensity values 34.

In some examples, the method comprises compressing the residual output pixel attribute values 34 to obtain compressed residual output pixel attribute values. For example, if an output pixel attribute value and its associated approximate value are stored using 20 bits, the residual output pixel attribute value will be initially represented using 20 bits. The method may comprise removing redundant bits from the square-rooted residual output pixel attribute values to reduce the memory used to store the residual output pixel attribute values 34 to, for example, 16 bits per value. The method may comprise square-rooting the residual output pixel attribute values 34 to reduce their numerical value. In this example, the square-rooted residual output pixel attribute values can be stored using 8 bits per value. The method may comprise removing the least significant bits of the residual output pixel attribute value, so that the compressed residual output pixel attribute values are stored using, for example, 6 bits per value. Square-rooting the residual output pixel attribute values 34 before removing the least significant bits, instead of after removing the least significant bits, may reduce rounding errors caused by removing the least significant bits.

More generally, compressing the residual output pixel attribute values 34 may enable a further reduction in the memory required to store the residual output pixel attribute values 34.

As mentioned, the method comprises, at step 106, storing data representative of the parameters of the function and data representative of the sets of residual output pixel attribute values 34. The data representative of the sets of residual output pixel intensity values 34 may comprise data representative of the compressed residual output pixel intensity values. The storing may comprise storing the data in a data storage 420.

Method 100a comprises storing a number of the sets of residual output pixel attribute values that is fewer than a total number of the mappings in the plurality of mappings. For example, sets of residual output pixel attribute values that lie on odd-numbered diagonals of the above-mentioned grid could be omitted when storing the residual output pixel attribute values in the data storage 420. This may further reduce the memory required to store the colour mapping.

The present method enables the encoding, or compressing, of the data representative of a mapping. Since the residual output pixel attribute values 34 can be stored using less memory than the exact output pixel attribute values 32, the total amount of data required to store the mapping is less than when storing the exact output pixel attribute values. The parameters of the function are additionally stored, but these are small in number, and the memory required to store them is insignificant in comparison with the memory saved by storing the residual output pixel attribute values 34 in place of the exact output pixel attribute values 32. By compressing the data, less memory is required to store the mapping. This enables a reduction in the size of the data storage 420, in turn reducing the area occupied by the data storage 420 on a motherboard.

Method 100 has been described above as applied to compressing data representative of a colour mapping. Other applications are envisaged. We describe another method, method 100b, in which the invention is applied to data representative of a local tonemapping look-up table.

Tonemapping is a technique used to transform pixel intensity values to approximate the appearance of a high dynamic range scene that is to be displayed using a display apparatus with a limited dynamic range. For instance, an image captured by an image sensor may represent pixel intensity values using 24 bits per pixel, while a display apparatus may only be capable of representing the pixel intensity values using 8 bits per pixel. Generally speaking, a tonemapping function is used to determine, based on input of a pixel intensity value, a tonemapped pixel intensity value. The input pixel intensity value is typically a luminance pixel intensity value, obtained by taking a weighted combination of the Bayer pixel intensity values in a given region of nine neighbouring Bayer pixels.

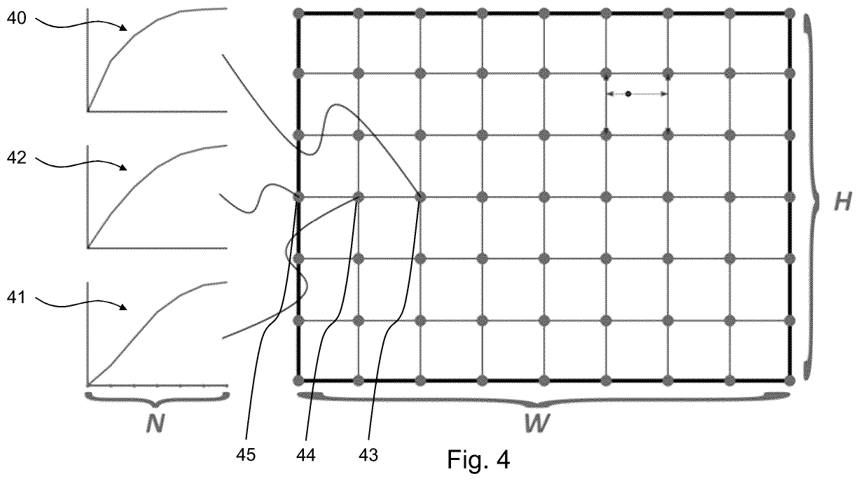

An example first tonemapping function 40 is illustrated in FIG. 4. The x-axis represents the input pixel intensity value, and the y-axis represents the tonemapped pixel intensity value. The tonemapping function is represented by a look-up table. The look-up table includes N predetermined pixel intensity values in association with corresponding tonemapped pixel intensity values. For a target pixel intensity value that is not one of the predetermined pixel intensity values, applying the tonemapping function comprises linearly interpolating from the two nearest predetermined pixel intensity values to determine the tonemapped pixel intensity value.

Local tonemapping is a technique in which different tonemapping functions are applied to different parts of an image. The image may be divided into a grid of (W−1)×(H−1) equally sized sections, as shown in FIG. 4. Different tonemapping functions may be defined for the nodes of the grid. As shown in FIG. 4, taking three exemplary nodes that are adjacent to each other, the first tonemapping function 40 is applied to a pixel at a first node 43, a second tonemapping function 41 is applied to a pixel at a second node 44, and a third tonemapping function 42 is applied to a pixel at a third node 45. Different tonemapping functions may be applied at each of the pixels at the other nodes of the image and/or mutually shared tonemapping functions may be applied at others of the pixels at the other nodes.

Determining the tonemapped pixel intensity value for a target pixel which is not at one of the nodes may proceed as follows. The four nodes that are nearest to the target pixel are identified. The tonemapping functions of each of the four nodes are evaluated, in each case using the pixel intensity value of the target pixel as input, to obtain respective tonemapped pixel intensity values. Bilinear interpolation from the four tonemapped pixel intensity values is used to determine the tonemapped pixel intensity value for the target pixel. The bilinear interpolation uses the coordinates of the four nodes and the coordinates of the pixel, as well as the four tonemapped pixel intensity values.

A tonemapping look-up table comprises, for each combination of (node x-coordinate, node y-coordinate, predetermined input pixel intensity value), a tonemapped pixel intensity value. Trilinear interpolation can be used to determine, for a target (pixel x-coordinate, pixel y-coordinate, input pixel intensity value), a tonemapped pixel intensity value. The tonemapping look-up table is similar to the colour mapping look-up table described above. The colour mapping look-up table comprises, for each combination of (predetermined red input pixel intensity value, predetermined green input pixel intensity value, predetermined blue input pixel intensity value), the vector (predetermined red output pixel intensity value, predetermined green output pixel intensity value, predetermined blue output pixel intensity value), and is thus a discrete 3D vector field. The tonemapping look-up table, on the other hand, is a discrete 3D scalar field.

Method 100 may be applied to data comprising a plurality of mappings representing the tonemapping look-up table. In this case, the one or more input data channels comprise an input pixel intensity value channel, and optionally one or more pixel location channels, such as a pixel x-coordinate channel and/or a pixel y-coordinate channel. The output data channel comprises a tonemapped pixel intensity value channel. By applying method 100 to the tonemapping look-up table, the data required to store the tonemapping look-up table may be reduced.

More generally, the input data channels may comprise a channel for a first pixel characteristic and a channel for a second pixel characteristic, wherein the second pixel characteristic is different from the first pixel characteristic. The two pixel characteristics may represent two different quantities. As an alternative to the example in which the input data channels comprise an input pixel intensity value channel and a pixel location channel, the input data channels may comprise, for example, an input colour channel and a pixel location channel.

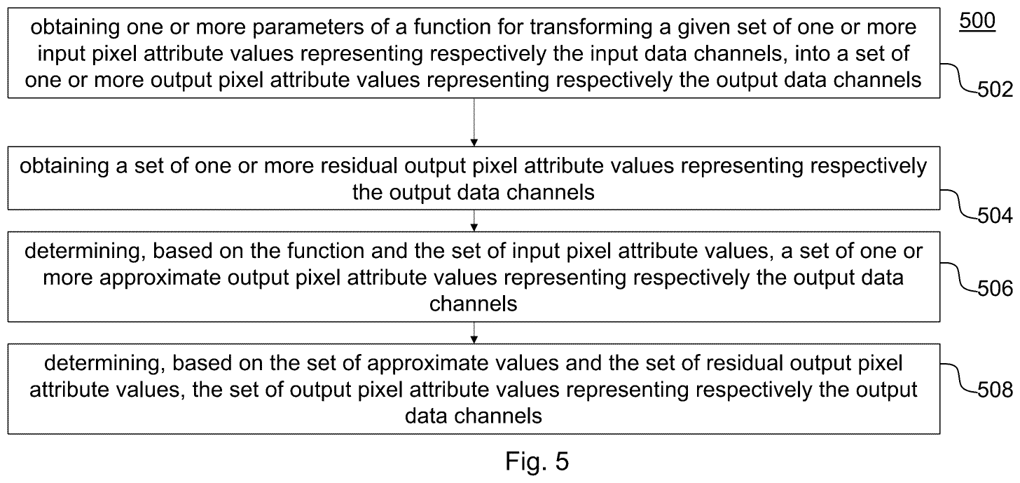

We now describe how the stored parameters and residual values may be used to determine a mapping from input pixel attribute values 31 to output pixel attribute values 35 with reference to method 500 shown in FIG. 5. Method 500 may be performed after the completion of method 100. Method 500 may be applied to either the colour mapping example or the tonemapping example.

The present invention provides two ways in which the stored function parameters and residual values can be used. Broadly speaking, the first, method 500i, is to reconstruct part or the entirety of the look-up table 30. The look-up table 30 can then be interpolated, as discussed previously, to determine a set of output pixel attribute values 35 for an arbitrary set of input pixel attribute values 31. The second, method 500ii, is to apply the function to an arbitrary set of input pixel attribute values 31 to determine an approximate set of output values, and then interpolate appropriately from the residual values to determine a set of residual values to be added to the approximate set of output values, to determine a set of output pixel attribute values 35 for the arbitrary set of input pixel attribute values 31. If the approximating function is nonlinear, the two methods may produce slightly different sets of output pixel attribute values 35 for the same set of input pixel attribute values 31, but the differences are in general unlikely to be substantial.

FIG. 5 shows a method for determining a mapping from a set of one or more input pixel attribute values 31 representing respectively one or more input data channels, to a set of one or more output pixel attribute values 35 representing respectively one or more output data channels. Methods 500i and 500ii are examples of method 500 and include the steps of method 500.

In broad overview, method 500 comprises:
in step 502, obtaining one or more parameters of a function for transforming a given set of one or more input pixel attribute values 31 representing respectively the input data channels, into a set of one or more output pixel attribute values representing respectively the output data channels;
in step 504, obtaining a set of one or more residual output pixel attribute values 34, 36 representing respectively the output data channels;
in step 506, determining, based on the function and the set of input pixel attribute values 31, 33, a set of one or more approximate output pixel attribute values representing respectively the output data channels; and
in step 508, determining, based on the set of approximate values and the set of residual output pixel attribute values 34, 36, the set of output pixel attribute values 35 representing respectively the output data channels.

In steps 502 and 504, obtaining the parameters of the function and the set of residual output pixel attribute values 34, 36 may comprise retrieving the parameters of the function and a set of residual output pixel attribute values 34 from the data storage 420. For example, the parameters of the function and all of the sets of residual output pixel attribute values 34 may be stored in the data storage 420 of a computing system 400 at a time at which the computing system 400 is manufactured, and retrieved later for use after an image has been captured using the computing system 400. Alternatively, the parameters and residual values may be received over a network, such as a wireless network. For example, the computing system 400 may receive the parameters of the function and the set of residual output pixel attribute values 34 from a central update system, which has performed an update process to update the mappings. The computing system 400 may replace its current look-up table 30 with new mappings determined by applying method 500i to the received parameters of the function and set(s) of residual output pixel attribute values 34.

The input data channels and output data channels in method 500 may be the same as the input data channels and output data channels in method 100. The parameters of the function are the same for method 500i as for method 500ii.

We firstly describe method 500i for reconstructing the look-up table 30.

As mentioned, the method comprises, at step 504, obtaining a set of one or more residual output pixel attribute values 34 representing respectively the output data channels.

In method 500i, the set of residual output pixel attribute values 34 is one of the sets of residual output pixel attribute values 34 that was stored in the data storage 420 at step 106 of method 100. The set of input pixel attribute values 31 referred to in method 500 is one of the predetermined sets of input pixel attribute values 31 of method 100a; that is, it is one of the sets of input pixel attribute values 31 for which the associated set of output pixel attribute values 32 is predetermined, and there is a mapping in the original look-up table 30 between the predetermined set of input pixel attribute values 31 and the predetermined (exact) set of output pixel attribute values 32. For example, the set of residual output pixel attribute values 34 may be the set of values (−0.1, 0.1) shown in FIG. 3b; this is associated with the set of input pixel attribute values 31 (1, 0.5) and the set of exact output pixel attribute values 32 (0.9, 0.6).

In method 500i, the set of residual output pixel attribute values 34 is the set that is associated with this predetermined set of input pixel attribute values 31. For example, the set of residual output pixel attribute values 34 may be stored in association with the associated predetermined set of input pixel attribute values 31. For example, the data storage 420 may store, at respective memory addresses, pairs of sets of pixel attribute values, each pair comprising a set of residual output pixel attribute values 34, and the corresponding predetermined set of input pixel attribute values 31.

As mentioned, the method comprises, at step 506, determining, based on the function and the set of input pixel attribute values 31, a set of one or more approximate output pixel attribute values representing respectively the output data channels.

In both methods 500i and 500ii, determining the set of approximate output pixel attribute values comprises applying the function to the set of input pixel attribute values 31. The method may comprise retrieving, from the data storage 420, an indication of the function. Alternatively, the function may be pre-programmed into an application specific integrated circuit used to perform method 500.

In method 500i, the set of approximate output pixel attribute values is one of the sets of approximate output pixel attribute values determined at step 104 of method 100. For example, the set of approximate output pixel attribute values may be (1, 0.5) for the set of input pixel attribute values 31 (1, 0.5), in the case referred to in FIG. 3b.

As mentioned, the method comprises, at step 508, determining, based on the set of approximate values and the set of residual output pixel attribute values 34, the set of output pixel attribute values 35 representing respectively the output data channels. In both methods 500i and 500ii, determining the set of output pixel attribute values 35 comprises performing an addition operation with the set of approximate output pixel attribute values and the set of residual output pixel attribute values 34. For example, the method may comprise adding the set of approximate output pixel attribute values to the set of residual output pixel attribute values 34 to obtain the set of output pixel attribute values 35. For example, the set of approximate output pixel attribute values (1, 0.5) may be added to the set of residual output pixel attribute values 34 (−0.1, 0.1) to obtain the set of exact output pixel attribute values 35 (0.9, 0.6).

In method 500i, the set of output pixel attribute values 35 is one of the predetermined sets of output pixel attribute values 32 that formed the look-up table 30 in method 100. That is, method 500i enables an exact set of output pixel attribute values 32 to be reconstructed. Method 500i as described thus far enables the decompression of the data stored in the data storage 420 to obtain the exact set of output pixel attribute values 32.

Method 500i also comprises (i) obtaining a further set of one or more residual output pixel attribute values 34 representing respectively the output data channels. For example, the further set of residual output pixel attribute values 34 may be the set of residual output pixel attribute values 34 (0.1, 0.1) in FIG. 3b.

Method 500i also comprises (ii) determining, based on the function and a further set of one or more input pixel attribute values 31 representing respectively the input data channels, a further set of one or more approximate output pixel attribute values representing respectively the output data channels. This may be performed in a similar fashion to step 506.

Method 500i also comprises (iii) determining, based on the further set of approximate output pixel attribute values and the further set of residual output pixel attribute values 34, a further set of one or more output pixel attribute values 35 representing respectively the output data channels. This may be performed in a similar fashion to step 508.

Method 500i also comprises obtaining yet further sets of residual output pixel attribute values 34 and determining yet further sets of output pixel attribute values 35 according to steps (i) to (iii) above. For example, the yet further sets of residual output pixel attribute values 34 may be the set of residual output pixel attribute values 34 (0, 0.1) for the set of input pixel attribute values 31 (1, 0) and the set of residual output pixel attribute values 34 (0.2, 0) for the set of input pixel attribute values 31 (0.5, 0.5) in FIG. 3b.

By repeating steps (i) to (iii) for a plurality of sets of residual output pixel attribute values 34, part, or the entirety, of the look-up table 30 can be reconstructed. Method 500 thus enables the colour mapping to be stored using less memory than a case in which the exact output pixel attribute values 32 are stored in their full form. Method 500i can then be used to find a target set of output pixel attribute values 35 from a target set of input pixel attribute values 33. In some examples, method 500i also comprises, based on a target set of input pixel attribute values 33 representing respectively the input data channels, interpolating from the set of output pixel attribute values 32 and the further set of output pixel attribute values 32 to obtain a target set of one or more output pixel attribute values 35 representing respectively the output data channels.

The target set of input pixel attribute values 33 is a set of input pixel attribute values for which it is desired to determine a set of exact output pixel attribute values 35. For example, the target set of input pixel attribute values 33 may represent a set of input pixel intensity values captured by the image sensor, representing respectively red, green and blue colour channels for a given pixel. As mentioned above, the input pixel intensity values may need calibration, and it may be desired to apply other colour transformations, such as skin tone enhancement, to the input pixel intensity values. In this example, it is desired to use the colour mapping to determine the output pixel intensity values of the red, green and blue colour channels. In the example of FIG. 3b, where the green colour channel is omitted, the target set of input pixel attribute values 33 may be (0.7, 0.2). The method may comprise bilinearly interpolating from the above-mentioned four sets of output pixel attribute values 32 to obtain the target set of output pixel attribute values 35, which in this case is (0.768, 0.276).

In examples in which there are three data channels, the interpolation comprises trilinear interpolation from the eight sets of output pixel attribute values 32 whose corresponding sets of input pixel attribute values 31 have the shortest distance to the target set of input pixel attribute values 33. In any case, the interpolation from the sets of output pixel attribute values 32 may comprise determining, based on the target set of input pixel attribute values 33, a plurality of sets of output pixel attribute values 32 from which to interpolate.

In examples in which the number of sets of residual output pixel attribute values is fewer than the number of mappings in the look-up table, method 500i may further comprise interpolating from the reconstructed sets of pixel attribute values to obtain estimates for the sets of predetermined output pixel attribute values that were omitted when storing the residual output pixel attribute values at step 106.

We now describe method 500ii, another method for finding a target set of output pixel attribute values 35 from a target set of input pixel attribute values 33. Whereas method 500i involves firstly performing a partial reconstruction of the look-up table 30, and secondly interpolating from the look-up table 30, method 500ii involves using the function to obtain an approximate target set of pixel attribute values, and then interpolating from the residual output pixel attribute values 34 to identify a target set of residual output pixel attribute values 36 to be added to the approximate target set of pixel attribute values.

As mentioned, the method comprises, at step 504, obtaining a set of one or more residual output pixel attribute values 36 representing respectively the output data channels. In method 500ii, this is the target set of residual output pixel attribute values 36. Obtaining this set comprises obtaining a plurality of sets of one or more residual output pixel attribute values 34 representing respectively the output data channels. The plurality of sets of residual output pixel attribute values 34 are associated with a respective plurality of the sets of input pixel attribute values 31. That is, as described above, the plurality of sets of residual output pixel attribute values 34 may be stored in association with their respective sets of input pixel attribute values 31.

In method 500ii, obtaining the target set of residual output pixel attribute values 36 further comprises, based on the target set of input pixel attribute values 33, interpolating from the plurality of sets of one or more residual output pixel attribute values 34 to obtain the target set of residual output pixel attribute values 36. For example, if the same four sets of residual output pixel attribute values 34 are used as those used in method 500i, and the target set of input pixel attribute values 33 is the same as that used in method 500i, the sets of residual output pixel attribute values 34 can be interpolated to obtain a target set of residual output pixel attribute values 36 of (0.068, 0.076).

More generally, if the input data channels comprise three data channels (e.g. red, green and blue colour channels) instead of two as in this example, then the plurality of sets of residual output pixel attribute values 34 comprises eight said sets of residual output pixel attribute values 34 instead of four, and the interpolating comprises trilinear interpolation from the eight sets of residual output pixel attribute values 34. In any case, the interpolation from the sets of residual output pixel attribute values 34 may comprise determining, based on the target set of input pixel attribute values 33, a plurality of sets of residual output pixel attribute values 34 from which to interpolate.

As mentioned, the method comprises, at step 506, determining, based on the function and the set of (target) input pixel attribute values, a set of one or more approximate output pixel attribute values representing respectively the output data channels. In this example, the set of target input pixel attribute values is (0.2, 0.7), and since the function is the identity matrix, the set of approximate output pixel attribute values is (0.2, 0.7).

As mentioned, the method comprises, at step 508, determining, based on the set of approximate values and the target set of residual output pixel attribute values 36, the (target) set of output pixel attribute values 35 representing respectively the output data channels. In this example, adding the set of approximate values (0.2, 0.7) to the target set of residual output pixel attribute values 36 (0.068, 0.076) leads to the target set of output pixel attribute values 35 (0.768, 0.276). This is the same as the result achieved by method 500i. However, in cases where the function is nonlinear, a slightly different result may be achieved.

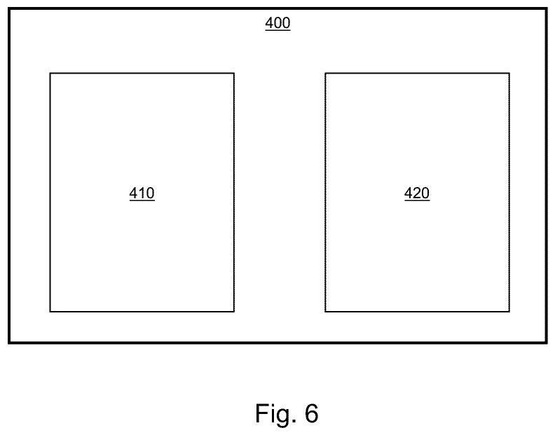

FIG. 6 shows a computing system 400 comprising at least one data processor 410 and data storage 420. The data storage 420 includes computer program code comprising instructions, which when executed on the data processor 410, cause the computing system 400 to perform any of the methods described herein, including methods 100, 100a, 100b, 100c, 500, 500i, or 500ii.

The computing system 400 may be an image processing system. The image processing system may be comprised in a suitable computing device, such as a smart telephone, a digital camera, or a computer. In some examples, the image processing system is located in device comprising at least one image sensor for generating one or more frames of image data. In other examples, the image processing system may be comprised in a computing device without image capturing capabilities but which may be communicatively coupled to an image capture device. The image processing system may be communicatively coupled to an image capture device over a local area network or a wide area network by any suitable wired or wireless communication means. Any steps of any of the methods 100, 100a, 100b, 100c, 500, 500i, or 500ii, can be implemented in hardware and performed using fixed function circuitry.

Whilst in the above-described examples, the methods 100, 100a, 100b, 100c, 500, 500i, and 500ii are performed by a programmable circuit or processor, any steps of any of the methods 100, 100a, 100b, 100c, 500, 500i, or 500ii, can be implemented in hardware and performed using fixed function circuitry. In some examples, all steps of such a method are performed using fixed function circuitry. In other examples, one or more steps are performed using fixed function circuitry, and one or more steps are performed using programmable circuitry.

Fixed function circuitry, as referred to herein, may comprise dedicated hardware circuitry that is configured specifically to perform a fixed function, and that is not reconfigurable to perform a different function. In this way, the fixed function circuitry can be considered distinct from a programmable circuit that is configured to receive and decode instructions defined, for example, in a software program. The fixed function circuitry may comprise application-specific integrated circuitry. The application-specific integrated circuitry may comprise one or more integrated circuits, and may be designed using a hardware description language such as Verilog and implemented as part of the fabrication of an integrated circuit. The application specific integrated circuitry may include any number of processors, microprocessor, and/or memory blocks, including RAM, ROM, EEPROM, or flash memory. The application specific integrated circuitry may comprise an image signal processor, configured to perform any of the methods described herein. Alternatively, the image processing system may be a non-specific computing device such as, for example, a desktop computer, or mobile computing device, configured to perform any of the methods described herein.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method for compressing data representative of a mapping for use in image processing, the data comprising a plurality of mappings representing a look-up table, said mappings being from a respective set of one or more input pixel attribute values representing respectively one or more input data channels, to an associated set of one or more output pixel attribute values representing respectively one or more output data channels, the method comprising:
determining, based on the plurality of mappings, one or more parameters of a function for transforming a given set of one or more input pixel attribute values representing respectively the input data channels, into a set of one or more estimated output pixel attribute values representing respectively the output data channels;
for a plurality of the sets of input pixel attribute values:
determining, based on the function and the set of input pixel attribute values, a set of approximate values of one or more of the associated set of output pixel attribute values; and
determining, based on the associated set of output pixel attribute values and the set of approximate values, a set of one or more residual output pixel attribute values; and
storing data representative of the parameters of the function and data representative of the sets of residual output pixel attribute values.

2. The method of claim 1, comprising compressing said residual output pixel attribute values to obtain compressed residual output pixel attribute values, and wherein the data representative of the sets of residual output pixel attribute values is data representative of the compressed residual output pixel attribute values.

3. The method of claim 1, wherein determining the set of residual output pixel attribute values comprises performing a difference operation with the associated set of predetermined output pixel attribute values and the set of approximate values.

4. The method of claim 1, wherein determining the parameters of the function comprises estimating the function from the plurality of mappings using random sample consensus.

5. The method of claim 1, wherein a total number of the sets of residual output pixel attribute values is fewer than a total number of the mappings in the plurality of mappings.

6. A method for determining a mapping from a set of one or more input pixel attribute values representing respectively one or more input data channels, to a set of one or more output pixel attribute values representing respectively one or more output data channels, the method comprising:
obtaining one or more parameters of a function for transforming a given set of one or more input pixel attribute values representing respectively the input data channels, into a set of one or more output pixel attribute values representing respectively the output data channels;
obtaining a set of one or more residual output pixel attribute values representing respectively the output data channels;
determining, based on the function and the set of input pixel attribute values, a set of one or more approximate output pixel attribute values representing respectively the output data channels; and
determining, based on the set of approximate values and the set of residual output pixel attribute values, the set of output pixel attribute values representing respectively the output data channels.

7. The method of claim 6, wherein determining the set of output pixel attribute values comprises performing an addition operation with the set of approximate output pixel attribute values and the set of residual output pixel attribute values.

8. The method of claim 6, wherein the set of input pixel attribute values is a target set of input pixel attribute values, and obtaining the set of residual output pixel attribute values comprises:
obtaining a plurality of sets of one or more residual output pixel attribute values representing respectively the output data channels, the plurality of sets of residual output pixel attribute values being associated with a respective plurality of sets of one or more input pixel attribute values representing respectively the input data channels; and
based on the target set of input pixel attribute values, interpolating from the plurality of sets of one or more residual output pixel attribute values to obtain the set of residual output pixel attribute values.

9. The method of claim 8, wherein the input data channels comprise three data channels, the plurality of sets of residual output pixel attribute values comprises eight said sets of residual output pixel attribute values, and the interpolating comprises trilinear interpolation from the eight sets of residual output pixel attribute values.

10. The method of claim 6, comprising:
obtaining a further set of one or more residual output pixel attribute values representing respectively the output data channels;
determining, based on the function and a further set of one or more input pixel attribute values representing respectively the input data channels, a further set of one or more approximate output pixel attribute values representing respectively the output data channels;
determining, based on the further set of approximate output pixel attribute values and the further set of residual output pixel attribute values, a further set of one or more output pixel attribute values representing respectively the output data channels; and
based on a target set of one or more input pixel attribute values representing respectively the input data channels, interpolating from the set of output pixel attribute values and the further set of output pixel attribute values to obtain a target set of one or more output pixel attribute values representing respectively the output data channels.

11. The method of claim 1, wherein the function comprises an affine transformation.

12. The method of claim 1, wherein the input data channels comprise three colour channels, and the output data channels comprise the three colour channels.

13. The method of claim 1, wherein the one or more input data channels comprises an input pixel intensity value channel, and the one or more output data channels comprises a tonemapped pixel intensity value channel.

14. The method of claim 1, wherein the input data channels comprise a channel for a first pixel characteristic and a channel for a second pixel characteristic, wherein the second pixel characteristic is different from the first pixel characteristic.

15. The method of claim 14, wherein the channel for the first pixel characteristic is an input pixel intensity value channel, the channel for the second pixel characteristic is a pixel location channel, and the one or more output data channels comprises a tonemapped pixel intensity value channel.

16. The method of claim 6, wherein the input data channels comprise three colour channels, and the output data channels comprise the three colour channels.

17. A system comprising a processor and a memory, the system being configured to perform a method for compressing data representative of a mapping for use in image processing, the data comprising a plurality of mappings representing a look-up table, said mappings being from a respective set of one or more input pixel attribute values representing respectively one or more input data channels, to an associated set of one or more output pixel attribute values representing respectively one or more output data channels, the method comprising:
determining, based on the plurality of mappings, one or more parameters of a function for transforming a given set of one or more input pixel attribute values representing respectively the input data channels, into a set of one or more estimated output pixel attribute values representing respectively the output data channels;
for a plurality of the sets of input pixel attribute values:
determining, based on the function and the set of input pixel attribute values, a set of approximate values of one or more of the associated set of output pixel attribute values; and
determining, based on the associated set of output pixel attribute values and the set of approximate values, a set of one or more residual output pixel attribute values; and
storing data representative of the parameters of the function and data representative of the sets of residual output pixel attribute values.

18. (canceled)

19. (canceled)

20. (canceled)
